(19) United States
(12) Patent Application Publication
(10) Pub. No.: US 2021/0197012 A1
(43) Pub. Date: Jul. 1, 2021

(54) MODULAR PHYSICAL THERAPY APPARATUS

(71) Applicant: Jeffrey Ciolino, East Quogue, NY (US)

(72) Inventor: Jeffrey Ciolino, East Quogue, NY (US)

(21) Appl. No.: 17/134,474

(22) Filed: Dec. 27, 2020

Related U.S. Application Data
(60) Provisional application No. 62/953,760, filed on Dec. 26, 2019.

(51) Int. Cl. A63B 22/00

(52) U.S. Cl. CPC A63B 22/0002; A63B 2210/52; A63B 2225/10; A63B 2022/0092

(57) ABSTRACT

A modular group therapy matrix apparatus includes tubular grip bars positioned in parallel longitudinal rows and transverse tubular grip bars which span between the rows. The grip bars are interconnected by a plurality of upright supports. Each upright support includes spring loaded snap couplings which are received within the ends of the hollow grip bars and which engage apertures in the grip bars to facilitate easy assembly and disassembly of the matrix. Physical therapy patients may grasp the grip bars, which comprises the outer periphery of the matrix, to perform exercises. A physical therapist or trainer may be positioned within the matrix to demonstrate exercises.

### BACKGROUND OF THE INVENTION

### 1. Field of the Invention

The present invention relates generally to physical therapy equipment and more specifically to a modular apparatus suitable for group therapy sessions.

### 2. Antecedents of the Invention

Physical therapy equipment, e.g. ergometers, treadmills, stationary bicycles, resistance bands, etc., have been primarily designed for individual patient use, with or without the assistance of a therapist or trainer.

The advantages of group physical therapy group have been known for some time. Exercising in a group benefits the patient as well as the therapist. Not only do group sessions reduce costs, it has been found that social interaction between physical therapy patients constitutes a significant recovery factor. The realization that one is not alone in his/her path to recovery motivates patients to strive forward and achieve therapy goals.

There is a need, however, for group therapy equipment which is readily adaptable to groups of different sizes and which promotes interaction between participants.

### SUMMARY OF THE INVENTION

A modular physical therapy apparatus suitable for group therapy exercises comprises a matrix array of a plurality of tubular horizontal longitudinal and transverse grip bars joined together and interconnected by a plurality of upright supports. Each upright support includes spring loaded snap couplings which are received within the ends of the hollow grip bars and which engage apertures in the grip bars to facilitate easy assembly and disassembly of the matrix.

A plurality of grip bars are positioned in longitudinal rows and transverse grip bars span across the rows at the ends of each individual longitudinal grip bar to provide a plurality of rectangular or square stations defined by opposed parallel grip bars. One or more patients may grasp each grip bar, which comprises the outer periphery of the matrix, to perform exercises. A physical therapist or trainer is positioned within the matrix to demonstrate exercises

From the foregoing compendium, it will be appreciated that an aspect of the present invention is to provide a modular physical therapy apparatus of the general character described which is not subject to the aforementioned disadvantages of the antecedents of the invention.

A feature of the present invention is to provide a modular physical therapy apparatus of the general character described which is readily adaptable for use by groups of various sizes.

A consideration of the present invention is to provide a modular physical therapy apparatus of the general character described which is simple to assemble yet durable.

Another feature of the present invention is to provide a modular physical therapy apparatus of the general character described which promotes social interaction between physical therapy patients.

A further aspect of the present invention is to provide a modular physical therapy apparatus of the general character described which relatively low in cost.

Another feature of the present invention is to provide a modular physical therapy apparatus of the general character described which may be employed in conjunction with multiple exercises.

Other aspects, features and considerations of the present invention in part will be obvious and in part will be pointed out hereinafter.

With these ends in view, the invention finds embodiment in various combinations of elements, arrangements of parts and series of steps by which the above-mentioned aspects, features and considerations and certain other aspects, features and considerations are attained, or with reference to the accompanying drawings and the scope of which will be more particularly pointed out and indicated in the appended claims.

### BRIEF DESCRIPTION OF THE DRAWINGS

The purpose and advantages of the present invention will be apparent to those of skill in the art from the following detailed description in conjunction with the appended drawings in which like reference characters are used to indicate like elements, and in which:

FIG. 1 is a schematized perspective illustration of a physical therapy apparatus constructed in accordance with the invention and depicting a plurality of longitudinal grip bars, transverse grip bars and connectors arrayed in a typical assembly;

FIG. 2 is a perspective illustration of a corner connector;

FIG. 3 is a perspective illustration of an intermediate “T” shaped ‘connector which joins a pair of longitudinal grip bars with a transverse grip bar;

FIG. 4 is a perspective illustration of a physical trainer demonstrating an exercise with patients preforming the demonstrated exercise;

FIG. 5 is a perspective illustration of an alternate configuration of the physical therapy apparatus wherein patients are practicing an eye hand coordination exercise; and

FIG. 6 is an enlarged depiction of netting from the circle 6 of FIG. 5.

### DETAILED DESCRIPTION

The present invention will now be described in detail with reference to the illustrations which are provided as illustrative examples of the invention so as to enable those skilled in the art to practice the invention. Notably, the figures and examples below are not meant to limit the scope of the present invention to a single embodiment, but other embodiments are possible by way of interchange of some or all of the described or illustrated elements.

Moreover, where certain elements of the present invention can be partially or fully implemented using known components, only those portions of such known components that are necessary for an understanding of the present invention will be described, and detailed descriptions of other portions of such known components will be omitted so as not to obscure the invention.

Referring now to the illustrations wherein the reference nominal 10 denotes generally a modular physical therapy apparatus constructed in accordance with and embodying the invention, it will be noted that the apparatus 10 may be configured for group physical therapy sessions and may be adjustably configured for accommodation with the dimensions of an exercise room and assembled to accommodate any number of patients.

By way of example, the assembly 10 may comprise a rectangular configuration with longitudinal row of hollow tubular grip bars 12, shown on the right, together with a parallel longitudinal row of hollow tubular grip bars 14, shown on the left. The grip bars 12, 14 are joined together and supported above a floor by four upright corner connector connectors 16 and a plurality of intermediate “T” shaped connectors 18. A plurality of hollow tubular transverse grip bars 20 extend orthogonally between the grip bars 12, 14 and are connected to opposed intermediate connectors 18. A transverse hollow grip bar 22 spans between the corner connector connectors 16 at the ends of each row.

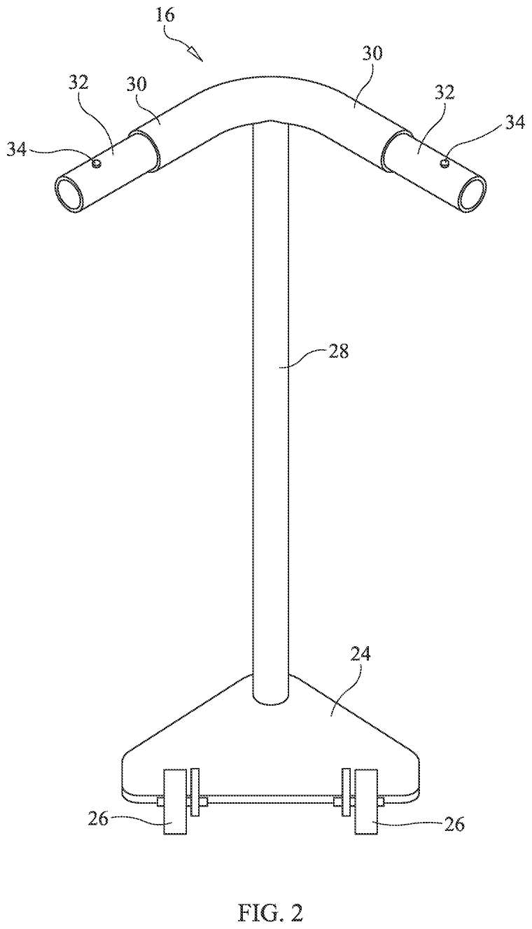

With reference to FIG. 2 it will be observed that each corner connector 16 includes a planar base 24 which rests on a floor surface. The base 24 includes a pair of wheels 26, which engage the floor only when the connector is tilted and free of any other components of the assembly 10. The connectors 16 may thus be easily transported for assembly of the apparatus or storage after disassembly. Extending vertically from the base 24 is an upright tube 28 having, at its upper end, a pair of perpendicular horizontal legs 30. A leg extension 32 projects axially from the end of each leg 30. The leg extensions include a spring loaded detent button 34.

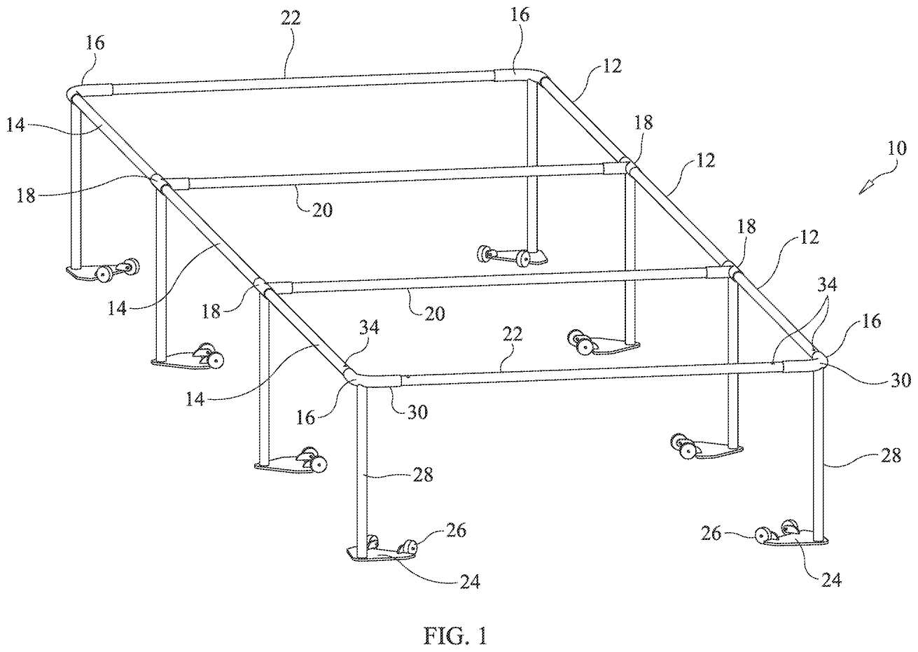

Pursuant to the invention, open ends of the hollow grip bars 12, 14 are received over the leg extensions 32 and are locked in place when the detent buttons snap through openings in the hollow grip bars 12, 14, as illustrated in FIG. 1.

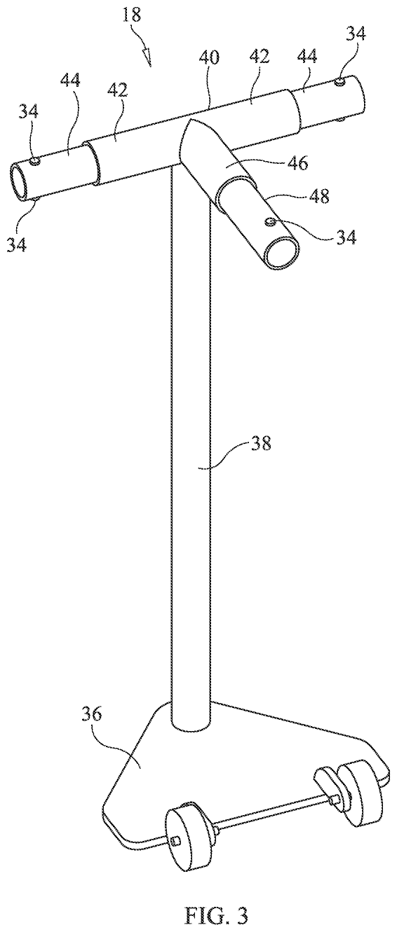

An intermediate connector 18, illustrated in FIG. 3, includes a base 36, substantially identical to the base 24. Extending vertically from the base 36 is an upright tube 38 having, at its upper end, a horizontal “T” shaped connector 40. The connector 40 includes a pair of coaxial legs 42, having leg extensions 44 and a third leg 46, which is perpendicular to the legs 42. The third leg 46 includes a leg extension 48. The leg extensions 44 join open ends of the hollow grip bars 12, 14 while the leg extensions 48 join open ends of the hollow transverse bars 20.

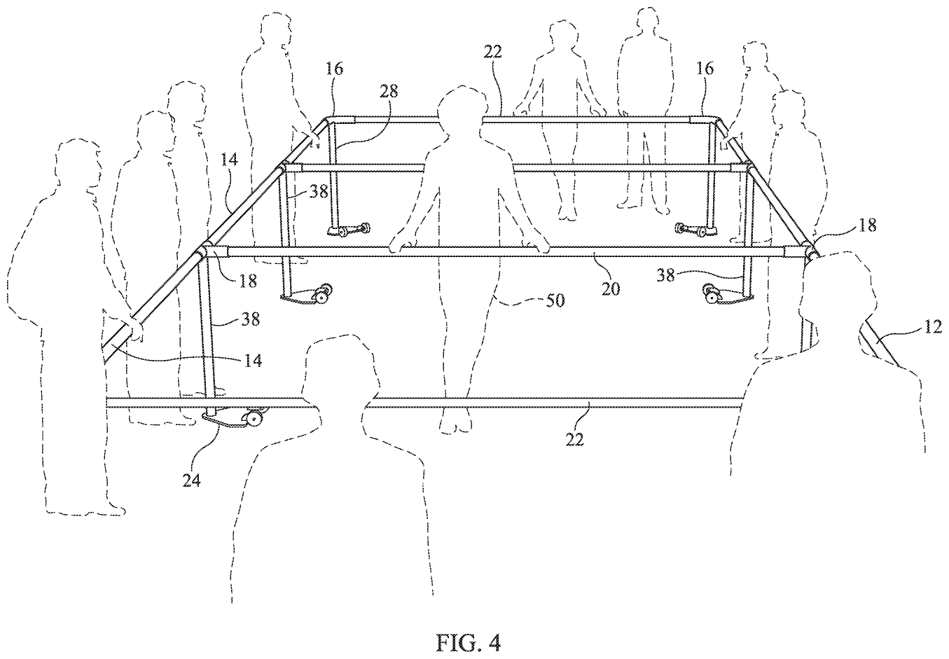

FIG. 4 illustrates a physical therapy instructor 50 (illustrated in dashed lines) positioned at an instructor station or zone between the longitudinal rows of horizontal grip bars 12,14; the instructor demonstrating exercises to a group of patients while grasping a transverse grip bar 20.

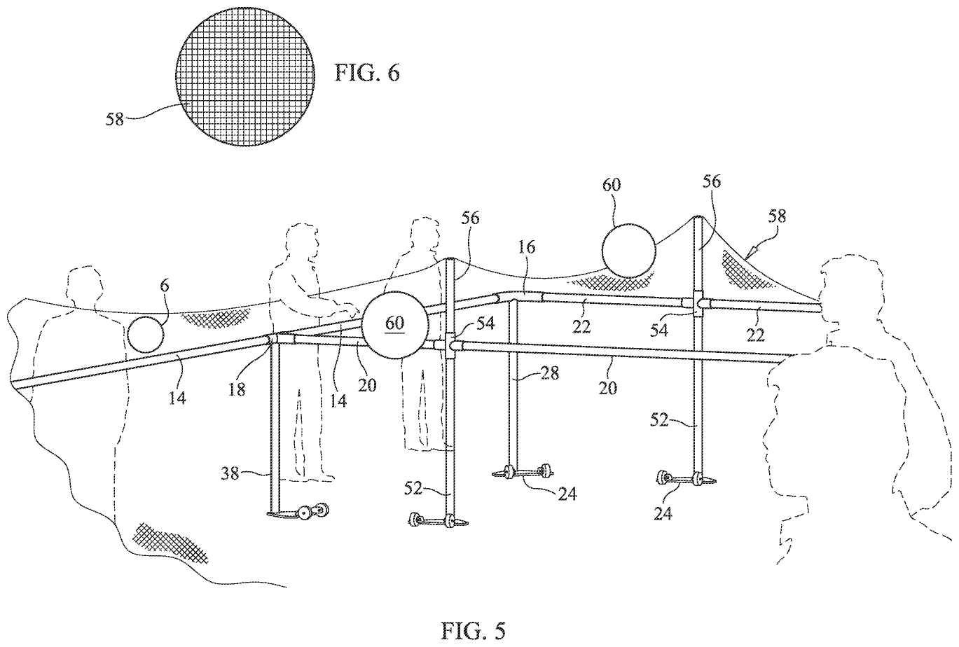

FIG. 5 illustrates an alternate configuration suitable for an eye hand coordination exercise wherein patients endeavor to maintain balls on a netting tent. In the FIG. 5 configuration, pairs of coaxial transverse grip bars 20 are joined together at a plurality of center connectors 52. The grip bars 12, 14 and 22 may be grasped for patient support while performing the exercise.

The center connector 52 includes a cross connector 54 at its upper end. The cross connector 54 includes a pair of coaxial horizontal legs having leg extensions similar to the leg extensions 42, 44 of the intermediate connector 18. The cross connector 54 also includes a vertical upright leg, substantially identical to the horizontal leg 46 having a leg extension 48. An open end of a vertical hollow pole 56 is received over the leg extension of the vertical upright leg of the cross connector 54.

The upper end of the hollow pole 56 is employed to support a net 58 which is draped over the assembly, in a manner similar to that of a tent pole. Tone or more lightweight balls, such as beach balls 60 are placed on the net 58 in an exercise for improving eye, arm and hand coordination with the goal of keeping the balls from falling off the net.

The particular combinations of elements and features in the above-detailed embodiment are exemplary only; the interchanging and substitution of these teachings with other teachings in this application are also expressly contemplated. As those skilled in the art will recognize, variations, modifications, and other implementations of what is described herein can occur to those of ordinary skill in the art without departing from the spirit and the scope of the invention as claimed.

Further, in describing the invention and in illustrating embodiments of the invention in the figures, specific terminology, numbers, dimensions, materials, etc., are used for the sake of clarity. However the invention is not limited to the specific terms, numbers, dimensions, materials, etc. so selected, and each specific term, number, dimension, material, etc., at least includes all technical and functional equivalents that operate in a similar manner to accomplish similar purpose. Use of a given word, phrase, number, dimension, material, language terminology, product brand, etc. is intended to include all grammatical, literal, scientific, technical, and functional equivalents. The terminology used herein is for the purpose of description and not limitation.

Having described the preferred embodiments of the invention, it will now become apparent to one of ordinary skill in the art that other embodiments incorporating the concept may be used. Moreover, those of ordinary skill in the art will appreciate that the embodiment of the invention described herein can be modified to accommodate and/or comply with changes and improvements in the applicable technology and standards referred to herein.

Having thus described the invention, there is claimed as new and desired to be secured by Letters Patent:

1. A modular group therapy apparatus comprising a matrix of at least one pair of longitudinal tubular hollow grip bars positioned in opposed parallel rows and at least one pair of transverse orthogonal tubular hollow grip bars which span between the at least one pair of longitudinal tubular hollow grip bars, a plurality of upright supports, each end of the longitudinal tubular hollow grip bars being releasably secured to one of the upright supports, each end of the transverse orthogonal tubular hollow grip bars being releasably secured to one of the upright supports, whereby physical therapy patients may grasp the longitudinal tubular hollow grip bars or the transverse orthogonal tubular hollow grip bars, which comprise the outer periphery of the matrix to perform exercises.

2. The modular group therapy apparatus in accordance with claim 1 further including a plurality of longitudinal tubular hollow grip bars in each parallel row, the longitudinal tubular hollow grip bars being interconnected by an intermediate upright support, an end of each intermediate transverse orthogonal tubular hollow grip bar being releasably secured to one of the intermediate upright supports.

3. The modular group therapy apparatus in accordance with claim 1 wherein each upright support includes spring loaded snap couplings which are received within the ends of the hollow grip bars, the snap couplings engaging apertures in the grip bars to facilitate easy assembly and disassembly of the matrix.

4. The modular group therapy apparatus in accordance with claim 2 wherein each parallel row includes at least three longitudinal tubular hollow grip bars and the apparatus includes at least two intermediate transverse orthogonal tubular hollow grip bars, a zone between the two intermediate transverse orthogonal tubular hollow grip bars and the longitudinal tubular hollow grip bars spaced between the two intermediate transverse orthogonal tubular hollow grip bars constituting an instructor station for exercise demonstrations.

5. The modular group therapy apparatus in accordance with claim 1 wherein each upright support includes a generally planar base having wheels which engage a support surface when the upright support is tilted, whereby the upright supports may be easily transported for assembly of the apparatus or storage after disassembly.

6. The modular group therapy apparatus in accordance with claim 2 wherein each upright support includes spring loaded snap couplings which are received within the ends of the hollow grip bars, the snap couplings engaging apertures in the grip bars to facilitate easy assembly and disassembly of the matrix.

7. The modular group therapy apparatus in accordance with claim 1 wherein each upright support includes pair of orthogonal legs, each leg having an extension dimensioned to be received within the end of one of the tubular hollow grip bars.

8. The modular group therapy apparatus in accordance with claim 7 wherein each leg extension includes a spring loaded snap coupling, the snap couplings engaging apertures in the grip bars to facilitate easy assembly and disassembly of the matrix.

9. The modular group therapy apparatus in accordance with claim 2 wherein the intermediate upright supports include a “T” shaped connector, the “T” shaped connector having a pair coaxial horizontal legs and an orthogonal horizontal leg, the coaxial legs being connected to the ends of the longitudinal tubular hollow grip bars and the orthogonal leg being connected to the end of the intermediate transverse orthogonal tubular hollow grip bar.

10. The modular group therapy apparatus in accordance with claim 1 further including a plurality of longitudinal tubular hollow grip bars in each parallel row, the longitudinal tubular hollow grip bars being interconnected by intermediate upright supports, a plurality of intermediate transverse orthogonal tubular hollow grip bars span between the intermediate upright supports, the intermediate transverse orthogonal tubular hollow grip bars being interconnected by a cross connector having an upright pole which extends to an elevation beyond that of the corner supports and the intermediate upright supports, the apparatus further including a netting tented over the apparatus from the upright poles, whereby the apparatus is well suited for eye hand coordination exercises with balls positioned on the netting.

11. An eye hand coordination physical therapy exercise device comprising a plurality of uprights supporting a horizontal array of tubular bars in a rectangular configuration, at least two poles within the rectangular configuration, a plurality of poles within the rectangular configuration, the poles extending to a height greater than the uprights, a mesh netting tented over the rectangular configuration, the netting being supported from the poles and draping over the rectangular configuration, the exercise device further including one or more lightweight spherical balls positioned on the netting.

12. The eye hand coordination physical therapy exercise device in accordance with claim 11 wherein the tubular bars are releasably secured to the uprights.

13. The eye hand coordination physical therapy exercise device in accordance with claim 12 wherein each upright includes pair of legs, each leg having an extension dimensioned to be received within an end of one of the tubular bars.

14. The eye hand coordination physical therapy exercise device in accordance with claim 11 wherein each upright includes a generally planar base having wheels which engage a support surface when the upright is tilted, whereby the upright may be easily transported for assembly of the apparatus or storage after disassembly.

15. The eye hand coordination physical therapy exercise device in accordance with claim 11 wherein each upright includes spring loaded snap couplings which are received within the ends of the tubular bars, the snap couplings engaging apertures in the tubular bars to facilitate easy assembly and disassembly of the device.

16. A method of practicing a group physical therapy eye hand coordination exercise comprising the following steps:
a) providing an eye hand coordination eye hand coordination physical therapy exercise device in accordance with claim 11;
b) placing a group patients in need of eye hand coordination physical therapy about the horizontal array of tubular bars;
c) Instructing the group of patients to watch the spherical balls and employ their hands to prevent the spherical balls from falling off the netting; and
d) placing one or more spherical balls atop of the netting.

17. The method of practicing a group physical therapy eye hand coordination exercise comprising in accordance with claim 16 including the further step of:
e) monitoring the group of patients and providing support.

18. A method of providing a group physical therapy program including the steps of:
a) providing a right quadrilateral matrix of hollow grip bars, the matrix including two parallel rows of at least three grip bars, the at least three grip bars being joined at couplings, two transverse end grip bars interconnecting to the ends of each row and at least two transverse intermediate grip bars spanning between the rows and connected to the couplings, the matrix space between the transverse intermediate grip bars and the rows defining an instructor station or zone;
b) placing a group patients in need of physical therapy exercises about the outer periphery of the matrix;
c) placing an instructor in the instructor station or zone:
d) advising the patients to emulate the instructor's exercise movements while grasping an grip bar with at least one hand.

19. The method of providing a group physical therapy program in accordance with claim 18 further including face to face social interaction between patients and the instructor.

20. An eye hand coordination physical therapy exercise device in accordance with claim 11 wherein the horizontal array of tubular bars comprise a support for patient balance.
